(19) United States
(12) Patent Application Publication
(10) Pub. No.: US 2009/0319294 A1
(43) Pub. Date: Dec. 24, 2009

(54) Managed distribution solution and methods thereof

(75) Inventors: Perry Phillips, Oviedo, FL (US); Tricia Pool, Maryland Heights, MD (US); Thaddeus Seymour, Lake Mary, FL (US)

Correspondence Address: BRYAN CAVE LLP, 211 NORTH BROADWAY, SUITE 3600, ST. LOUIS, MO, 63102-2750, US

(73) Assignee: CuraScript, Inc.

(21) Appl. No.: 12/214,360

(22) Filed: Jun. 18, 2008

(51) Int. Cl. G06Q 50/00

(52) U.S. Cl. 705/2; 705/40

(57) ABSTRACT

The managed distribution solution (“MDS”) of the present invention includes systems and methods for giving the point-of-service provider (“POS”) (i.e., physicians, home infusion, clinics, long term care, etc.) an alternative to the traditional buy and bill model. In one exemplary embodiment in accordance with the present invention, a processing site is configured for communicating with a distributor, a Client and a POS to facilitate delivery of a Product from a distributor to the POS. In another exemplary embodiment of the present invention, a billing system is associated with the processing site for facilitating billing for Products delivered to POS to a Client, when a patient of the Client receives the Product from the POS.

### FIELD OF THE INVENTION

This invention relates to methods for medical, health care, and pharmaceutical product distribution, namely, methods for selling products directly to a health plan, while shipping directly to the point-of-service.

### BACKGROUND OF THE INVENTION

In the traditional buy and bill model of medical, health care, and pharmaceutical product (collectively, “Products” and individually a “Product”) distribution, the point-of-service provider (e.g., physicians, home infusion providers, physician clinics or group practices, pharmacist, medical practitioner, nurse, veterinarian, long term care facilities, and other health care providers, and the like) (collectively, “POS”) will call the distributor to order Products. The POS then will add the Products into inventory once they are received from the distributor. When a patient visits the POS, the POS may call the patient's medical plan or use a website associated with the medical plan if Prior Authorization (“PA”) is necessary to verify the scope of the patient's medical or pharmacy benefit. This verification may occur in advance or at the time of the patient visit. For example, if the POS knows that a patient is coming in for a high dollar injection (e.g., a red blood cell stimulating factor); the POS may verify whether the injection is covered by the patient's medical plan. Even when a PA has not been secured, the patient may still receive the injection, but the patient may have to pay the POS for the injection and then seek reimbursement from his or her health plan after the POS administers the injection.

From an inventory perspective, after administration to the patient the POS may then take the injection out of inventory. An administrator of the POS will count the remaining inventory of Product at some pre-determined time (e.g., at the end of the day or week). The remaining inventory count may then be used to do determine future ordering numbers from the distributor.

Meanwhile, after the patient receives the injection, the POS (or the POS's billing agent) will file a claim with the patient's health plan to be reimbursed for the injection. The POS must then wait for the medical plan to pay (which oftentimes can take over 90 days) or for the medical plan to deny the reimbursement. Approximately a month after ordering the pharmaceutical Products from the distributor, the POS will receive an invoice from the distributor for the pharmaceutical Products that comprise the injection. The POS will then pay the distributor for this Product. It is not uncommon for the POS to be provided extended payment terms (e.g., 60 days) from the distributor which extends the due date for payment.

One alternative to the buy and bill method is the current Medicare Competitive Acquisition Program for Part B Drugs and Biologicals (“CAP”), which was required by the Medicare Prescription Drug, Improvement and Modernization Act of 2003. The CAP program is an alternate to the “buy and bill” system which allows certain POS who elect to participate in CAP to buy Medicare Part B drugs and biological Products (“CAP Drugs”) directly from contracted CAP vendors.

For example, in the CAP program, the POS knows that a patient is coming in, and so the POS must send in any CAP Drug orders for the patient to a CAP vendor ahead of time. The POS must provide the specific dosage and specific reason for the pharmaceutical in the order. The CAP vendor verifies the patient's eligibility and then bills the patient for the patient's cost sharing amount (typically 20%), and the Medicare program for the government's portion (typically 80%). If the patient cancels or otherwise does not receive the CAP drug, the POS may return the CAP drug to the CAP vendor. If the patient does not cancel, but rather comes in with an unanticipated medical need (e.g., low iron levels), the CAP regulations require the CAP vendor to have in place emergency procedures for supplying the POS the CAP Drug in an expedited manner. Throughout this process, ownership of the CAP Drug is retained by the CAP vendor until the CAP Drug is administered to the patient, at which point the patient “owns” the CAP Drug.

The CAP program demonstrates the need for alternatives to the traditional buy and bill model.

### SUMMARY OF PRESENT INVENTION

One such alternative is the managed distribution solution (“MDS”), which allows for the POS to carry Products in inventory by having the distribution company sell Products directly to the POS and then assigning the obligation to pay for such Products to the patient's health plan upon approval by the health plan. The managed distribution solution (“MDS”) of the present invention comprises systems and methods for providing the point-of-service provider an alternative to the traditional buy and bill model of pharmaceutical and medical supply distribution. In one exemplary embodiment in accordance with the present invention, a processing site is configured for communicating with a distributor, a health plan Client of the distributor (“Client”) and a POS to facilitate delivery of a Product from a distributor to the POS. In another exemplary embodiment of the present invention, a billing system is associated with the processing site for facilitating billing for Products delivered to POS to a Client, when a patient of the Client receives the Product from the POS.

The present invention also includes methods for facilitating the managed distribution solution. In one exemplary method in accordance with the present invention, a POS and Client contract and register with a distributor. Registration takes place through a manual or web-based electronic processing system developed and owned by the distributor. POS can use the processing to place orders for Products from a distributor and to receive Products from the distributor. The processing system can also include methods for verifying the patient and treatment options and for facilitating payment between a distributor and POS, distributor and a Client, Client and patients and POS and patients. The eligibility and processing system may be accomplished through both a web-based system and through manual processes.

### BRIEF DESCRIPTION OF THE DRAWINGS

The invention will be better understood from a reading of the following detailed description, taken in conjunction with the accompanying Figures in the drawings in which:

FIG. 1 illustrates a block diagram of an exemplary managed distribution solution system in accordance with the present invention;

FIG. 2 illustrates a block diagram of an exemplary processing site in accordance with the present invention;

FIG. 3 illustrates a block diagram of an exemplary registration procedure in accordance with the present invention;

FIG. 4 illustrates a block diagram of an exemplary distribution method in accordance with the present invention;

FIG. 5 illustrates an exemplary interface in accordance with the present invention;

FIG. 6 illustrates an exemplary home menu in accordance with the present invention;

FIG. 7 illustrates another exemplary home menu in accordance with the present invention; and

FIG. 8 illustrates an exemplary method of claim adjudication in accordance with the present invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

### DETAILED DESCRIPTION OF THE DRAWINGS AND EXAMPLES OF EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments can be realized and that logical and mechanical changes can be made without departing from the spirit and scope of the invention. Thus, the detailed description herein is presented for purposes of illustration only and not of limitation. For example, the steps recited in any of the method descriptions can be executed in any order and are not limited to the order presented.

For the sake of brevity, conventional data networking, application development and other functional aspects of the systems (and components of the individual operating components of the systems) can not be described in detail herein. Furthermore, the connecting lines shown in the various figures contained herein are intended to represent exemplary functional relationships and/or physical couplings between the various elements. It should be noted that many alternative and/or additional functional relationships and/or physical connections can be present in a practical system.

The present invention can be described herein in terms of functional block components, screen shots, optional selections and various processing steps. It should be appreciated that such functional blocks can be realized by any number of hardware and/or software components configured to perform the specified functions. For example, the present invention can employ various integrated circuit components (e.g., memory elements, processing elements, logic elements, look-up tables, and the like), which can carry out a variety of functions under the control of one and/or more microprocessors and/or other control devices. Similarly, the software elements of the present invention can be implemented with any programming and/or scripting language such as C,. C++, Java, COBOL, assembler, PERL, Visual Basic, SQL Stored Procedures, extensible markup language (XML), hypertext markup language (HTML), with the various algorithms being implemented with any combination of data structures, objects, processes, routines and/or other programming elements. Further, it should be noted that the present invention can employ any number of conventional techniques for data transmission, signaling, data processing, network control, and the like.

The present invention is described herein with reference to block diagrams and flowchart illustrations of methods, apparatus (e.g., systems), and computer program Products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions can be loaded onto a general purpose computer, special purpose computer, and/or other programmable data processing apparatus to produce a machine, such that the instructions that execute on the computer and/or other programmable data processing apparatus create means for implementing the functions specified in the flowchart block and/or blocks.

These computer program instructions can also be stored in a computer-readable memory that can direct a computer and/or other programmable data processing apparatus to function in a particular manner, such that the instructions stored in the computer-readable memory produce an article of manufacture including instruction means which implement the function specified in the flowchart block and/or blocks. The computer program instructions can also be loaded onto a computer and/or other programmable data processing apparatus to cause a series of operational steps to be performed on the computer and/or other programmable apparatus to produce a computer-implemented process such that the instructions which execute on the computer and/or other programmable apparatus provide steps for implementing the functions specified in the flowchart block and/or blocks.

Accordingly, functional blocks of the block diagrams and flowchart illustrations support combinations of means for performing the specified functions, combinations of steps for performing the specified functions, and program instruction means for performing the specified functions.

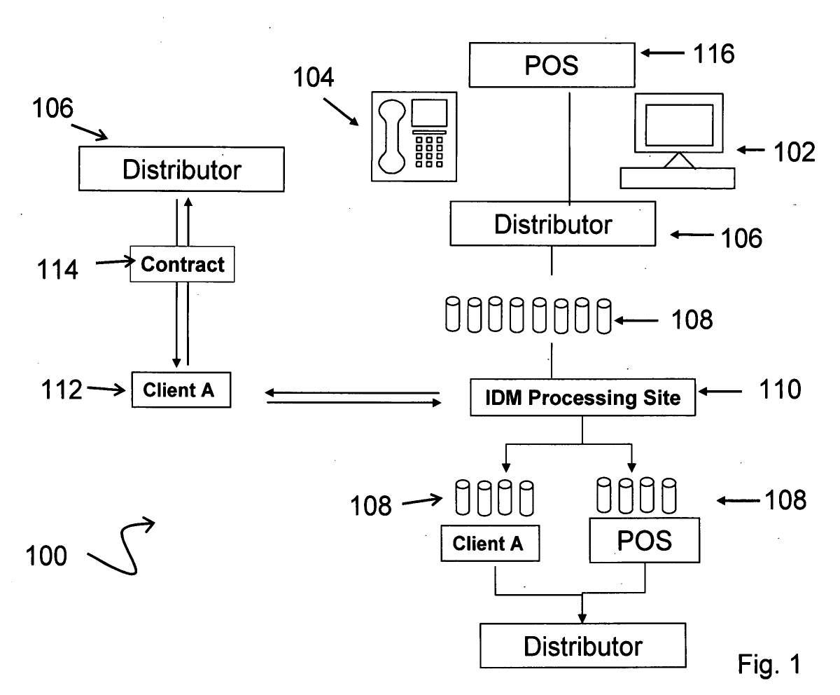

A managed distribution solution (“MDS”) is illustrated in an exemplary block diagram depicted in FIG. 1, in accordance with the present invention. MDS 100 comprises a distributor 106 that communicates with a point-of-service (“POS”) 116, a Client 112 and a processing site 110.

For example, in one embodiment, distributor 106 enters into an agreement with Client 112 in which Client 112 agrees to be part of the MDS 100 program and to pay distributor 106 directly for any Products 108 purchased by POS 116 for use by one of Client's 112 customers.

Client 112 can enter into an agreement with distributor 106. By entering into an agreement with distributor 106, Client can sign an agreement, verbally agree, and/or the like. After or as part of entering into the agreement, Client 112 can register information with distributor 106 through processing site 110, in person, through a computer and/or Internet, through software and/or hardware, through a third-party, through a kiosk and/or registration terminal, and/or by any other direct or indirect means, communication device or interface for Client 112 to contact and provide information to distributor 106. An exemplary registration procedure in accordance with the present invention will be described in greater detail below.

Distributor 106, as used herein, can include any type of Product distributor, including, but not limited to, a medical Product distributor, specialty pharmacy distributor, pharmaceutical distributor, medical machinery and/or supply distributor, and the like. POS 116 may include any type of point-of-service described herein. Client 112, as used herein, comprises any type of medical plan, including, but not limited to, a government health plan, private health plan, insurance company, and/or the like. While POS 116 and Client 112 are generally described herein, each may comprise one or more computer processors, databases, servers, networks/or the like for communicating with distributor 106 and/or processing site 110.

As used herein, the term “Product” includes, but is not limited to, medication, a medical device, any type of medical supply, a vaccine, an over-the-counter pharmaceutical, a prescription pharmaceutical, a biological product, and/or the like.

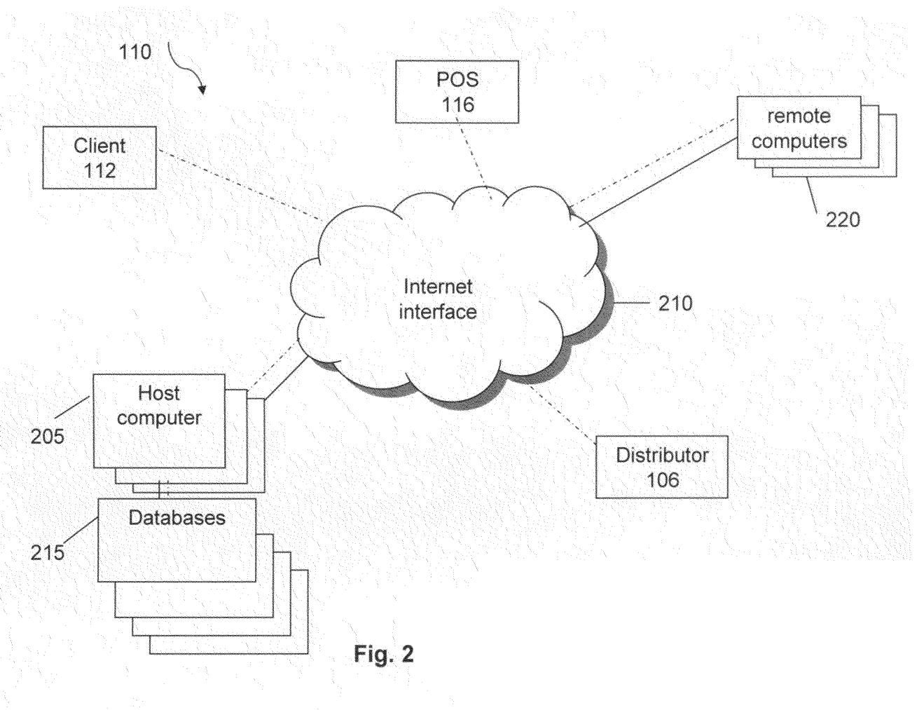

Processing site 110 can comprise any type of computing system. In one embodiment in accordance with the present invention, and with reference to an exemplary block diagram as illustrated in FIG. 2, processing site 110 comprises one or more host computers 205, a network and/or Internet interface 210, and/or more databases 215, and one or more remote computers 220.

Host computers 205 and remote computers 220 can comprise one and/or more of the following: a host server and/or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, host computer 205 can include an operating system (e.g., MVS, Windows NT, 95/98/2000/XP, OS2, UNIX, MVS, TPF, Linux, Solaris, MacOS, AIX, etc.) as well as various conventional support software and drivers typically associated with computers.

Host computer 205 communicates with databases 215, interface 210 and/or remote computers 220 through a direct connection and/or network connection. As used herein, the term network can include any electronic communications means which incorporates both hardware and software components of such. Communication among the components and/or parties in accordance with the present invention can be accomplished through any suitable communication channels, such as, for example, a telephone network (such as a public switched telephone network or Integrated Services Digital Network (ISDN)), an extranet, an intranet, Internet, point-of-interaction device (personal digital assistant, cellular phone, kiosk, etc.), online communications, off-line communications, wireless communications, transponder communications, local area network (LAN), wide area network (WAN), networked and/or linked devices and/or the like. Moreover, the invention can also be implemented using TCP/IP communications protocols, IPX, Appletalk, IP-6, NetBIOS, OSI and/or any number of existing and/or future protocols. If the network is in the nature of a public network, such as the Internet, it can be advantageous to presume the network to be insecure and open to eavesdroppers. One encryption program that may be used, but is not limited to, is for example, “Blowfish.” In addition, the key bit exceeds 128-bits for sites located within the United States. Any sites located outside of the borders of the United States will use key bit encryption strength approved by the US government, such as for example, 56-bit key lengths. According to some public safety regulations a key of 128-bit meets or exceeds the level deemed necessary to transmit information over the internet or other electronic means. Specific information related to the protocols, standards, and application software utilized in connection with the Internet is generally known to those skilled in the art and, as such, need not be detailed herein.

Databases 215 can comprise one or more local, remote or other databases used for information storage and retrieval. Databases 215 can be a graphical, hierarchical, relational, object-oriented or other database. The databases are configured such that information can be suitably retrieved from the databases and provided to distributor 106, Client 112, and/or POS 116 using any type of identifier or access information. Internet interface 210 can comprise any type of website and/or gateway through which POS 116, distributor 106 and/or Client 112 can communicate and/or retrieve information.

With reference again to the exemplary embodiment illustrated in FIG. 1, after Client 112 signs a contract with distributor 106 and/or registers with distributor 106, one or more POS associated with Client 112 must register with distributor 106 through a processing site 110.

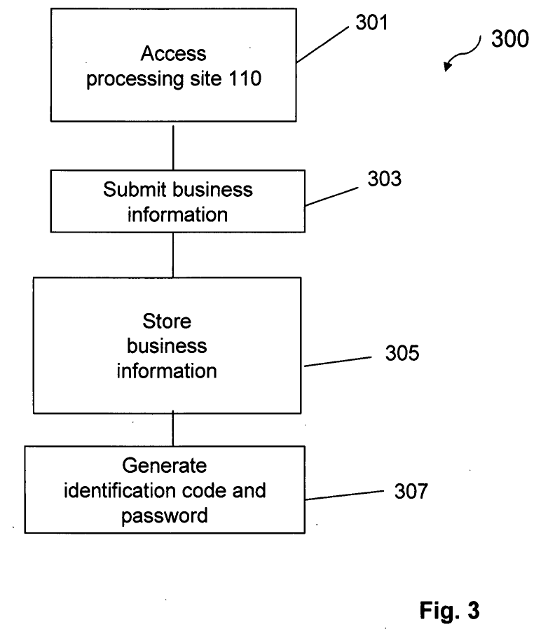

For example, FIG. 3 illustrates an exemplary registration procedure 300 in accordance with an exemplary embodiment of the present invention. During registration, POS 116 and/or Client 112 can access processing site 110 (step 301) to register with distributor 106. POS 116 and/or Client 112 can access processing site 110 through any type of network described herein. After accessing site 110, POS 116 and/or Client 112 may then submit business information through processing site 110 (step 303). Alternatively, and/or in addition to, POS 116 and/or Client 112 can contact distributor 106 and submit business information in person, through a third-party, through a kiosk and/or registration terminal, and/or by any other direct or indirect means, communication device or interface (including, but not limited to, a telephone, facsimile, letter, and/or web-based processing system).

For example, in one embodiment of the present invention, processing site 110 software can be installed on the computers of POS 116 and/or Client 112. The software, for example, can be written for any type of operating platform and/or operating system using Visual Basic 6.0, Visual C++, and/or the like.

Upon receiving the business information, processing site 110 can store the business information in a database, digital format and/or any storage medium known in the art (step 305). For example, in one embodiment, processing site stores the business information of POS 116 and/or Client 112 on database 215. Alternatively and/or in addition to, and processing site 110 can be configured to populate a website with POS 116-specific information (step 307). By populating a website with POS 116 information, processing site 110 can be configured to store and/or encode POS 116 business information in browser-readable format. For example, in HTML, Java, C or any type of format.

As used herein, business information can include information regarding the business and/or services of POS 116 or Client 112, such as, for example, POS 116 business information may include practice type, medical plans accepted, telephone numbers, business hours, accounting procedures, internal business information, general business information such as maps, appointment information, emergency contact information, licenses information, credit information, personnel information (including, but not limited to physician specific information), delivery information (such as, for example, delivery dates, times, and/or locations) and/or any other type of business and/or practice care information of POS 116.

Client 112 business information may include company information, coverage information, accounting procedures, personnel information, pricing and ordering information, POS information, reimbursement information, approval information and the like. For example, in one exemplary embodiment in accordance with the present invention, processing site 110 is configured such that it can communicate with one or more Client 112 databases to verify POS 116 patient information, medical coverage, reimbursement rates and information and/or the like.

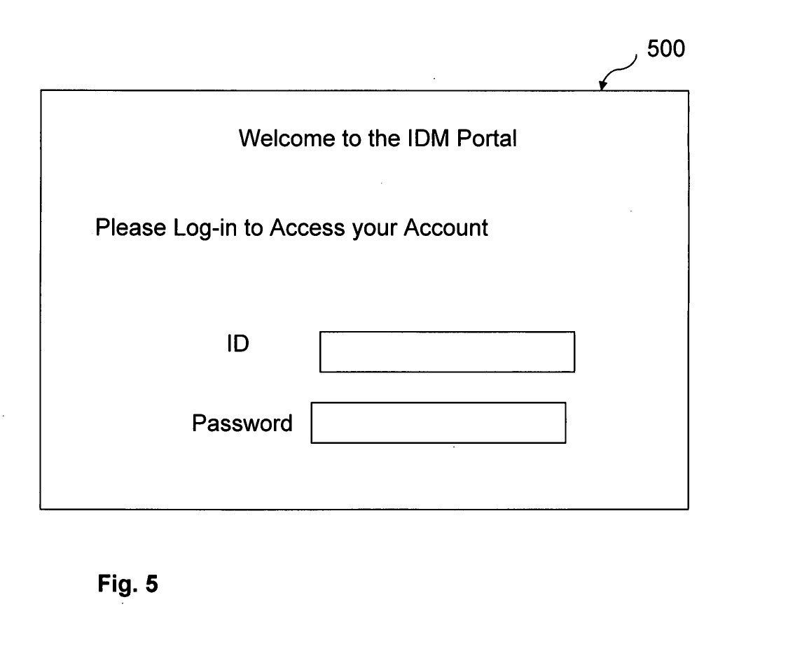

By submitting business information, POS 116 and/or Client 112 may use one or more informational screens, touch screens, drop down menus, keyboards, or the like to enter in information. Processing site 110 may comprise any type of hardware and/or software for receiving, storing, processing and/or providing information. For example, with reference to an exemplary embodiment depicted in FIG. 5, processing site 110 may comprise a software interface 500 that is configured as a portal to distributor 106, Client 112 and/or POS 116 information. For example, POS 116 and/or Client 112 can log into interface 500 using an identification code and password. The identification code and password can be generated by POS 116 and/or Client 112 during registration (step 307). The identification code and password can be any type of number or word or combination thereof for identifying POS 116 and/or Client 112.

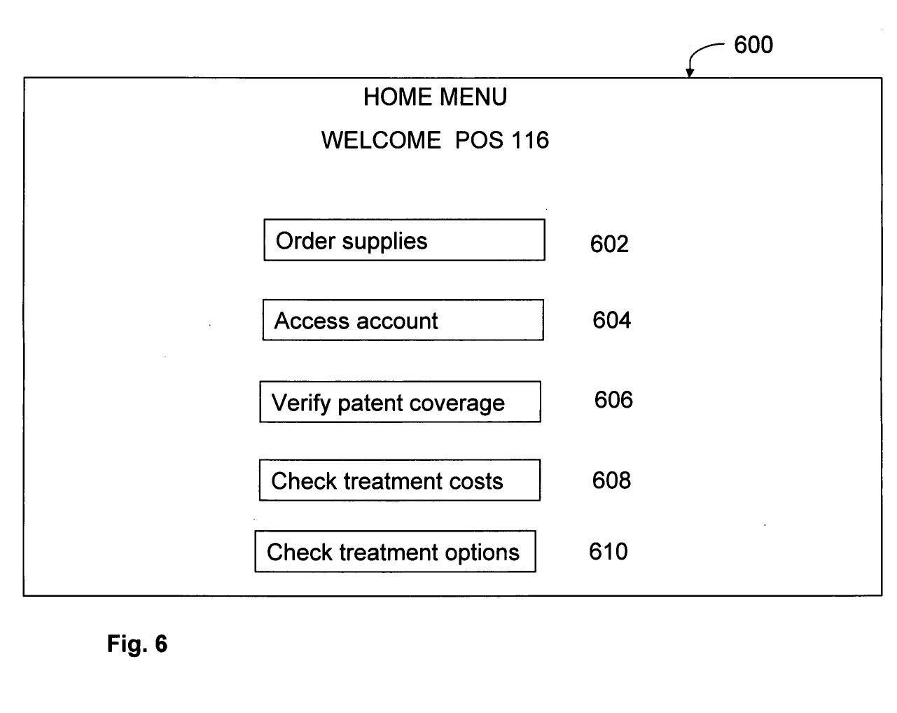

After logging into the portal, POS 116 and/or Client 112 may access a home menu to facilitate providing and/or receiving information. An exemplary diagram of a home menu 600 in accordance with the present invention is provided in FIG. 6. Home menu 600 can be configured to be customized and/or individualized to each POS 116 and/or Client 112. Home menu 600 may also be configured to be identical to each POS 116 and/or Client 112. For example, exemplary home menu 600 provides options for POS 116. These options can include, but are not limited to, ordering supplies 602, accessing account 604, verifying patient coverage 606, checking treatment costs 608, and/or checking treatment options 610. While the present invention contemplates providing POS 116 with a variety of options through home menu 600, the preceding has been depicted for illustration purposes only.

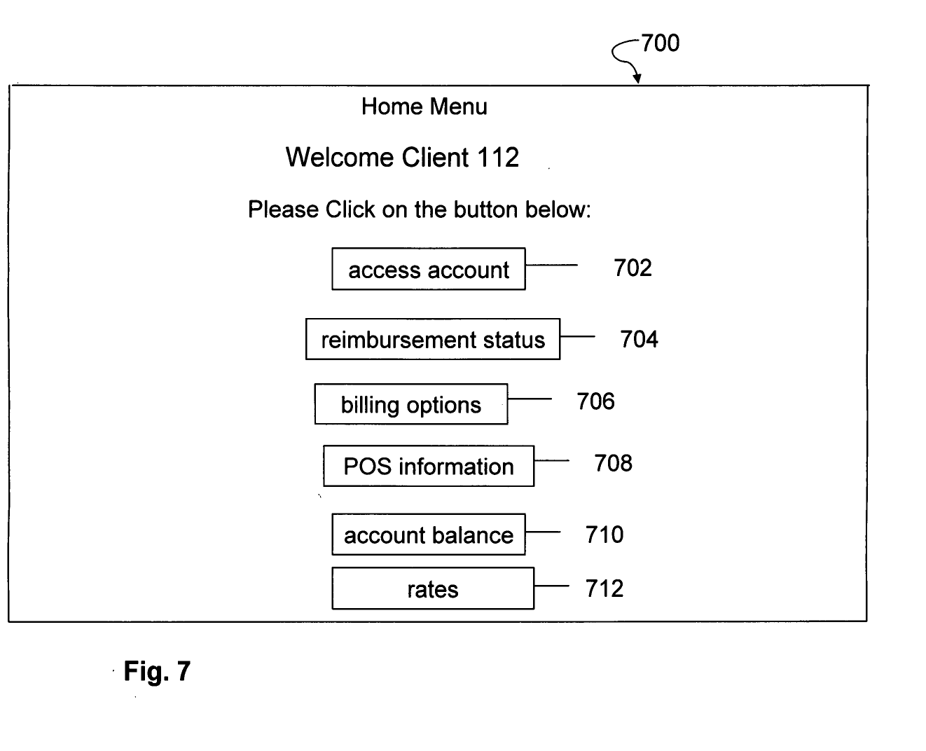

With reference to an exemplary screen shot in accordance with the present invention, Client 112 may access processing site and see a home menu 700 as illustrated in FIG. 7. Home menu 700 can be configured to provide information retrieval and/or submission options for Client 112. These options may include, but are not limited to accessing account 702, checking reimbursement status 704, billing options 706, POS information 708, account balance 710, rates 712, J codes, Product costs, and/or Average Sales Price (“ASP”) information. While the present invention contemplates providing Client 112 with a variety of options through home menu 700, the preceding have been depicted for illustration purposes only.

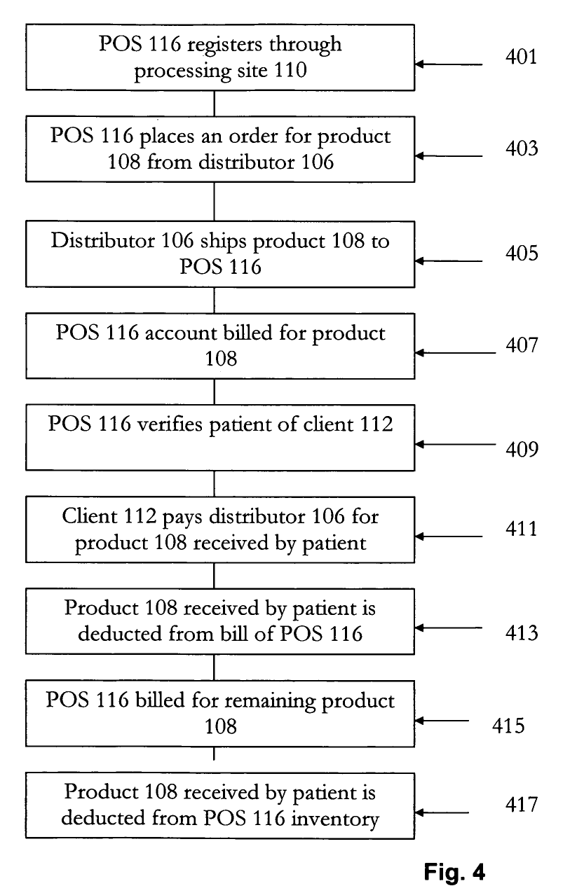

With reference again to the exemplary MDS 100 illustrated in FIG. 1 and to an exemplary block diagram illustrated in FIG. 4, a distribution method 400 in accordance with the present invention is provided. After Client 112 registers with distributor 106, POS 116 can register with distributor 106 through processing site 110 (step 401). As described herein, POS 116 can register through a website, in person, and/or any other method. POS 116 can then place an order for a Product with distributor 106 (step 403). By placing an order for a Product 108, POS 116 can contact distributor 106 via telephone 104, via a computer 102 connected to processing site 110 and/or any other method for contacting distributor 106. POS 116 can place orders daily, weekly, monthly and/or at any other interval. For example, if POS 116 regularly uses a Product such as Gardasil, POS 116 can go through processing site 110 and order ten vials to use in the upcoming month. The vials can then shipped to POS 116 through the normal course of business and/or delivered in any other manner to POS 116 (step 405). At that time, and/or at any other time, an account of POS 116 is billed by distributor 106 for Product 108 (step 407).

Meanwhile, before, after and/or at the time POS 116 sees a patient of Client 112 patient that is being prescribed Product 108 (e.g., Gardasil), POS 116 can use processing site 110 to pull up the patient's name and to seek approval for the medication (i.e., determine whether the Product is covered for the patient, whether Gardasil is appropriate, or whether a generic drug should be substituted) (step 409).

Once the patient comes in and/or after the patient receives Product 108, Client 112 shall pay distributor 106 directly for Product 108 (step 411) in conformance with the contract between Client and distributor. By paying distributor 106 directly, Client 112 may pay through an automatic billing and payment procedure run through processing site 110 from distributor 106, through accounting invoices from distributor 106, through a third-party billing coordinator, and/or through any other manner for paying a bill. Once Product 108 is billed through to Client 112, that Product 108 can be deducted from POS'S 116 account (step 413). Accordingly, POS 116 can then receive a bill from distributor 106 for only the Products 108 remaining in inventory (step 415). Product 108 can also be deducted from the inventory of POS 116 by processing site 110 and/or by POS 116 (step 417).

By deducting from the inventory of POS 116, Product 108 inventory levels can be communicated to processing site 110 either automatically or by POS 116. For example, in one embodiment, inventory of Product 108 is registered by POS 116 with processing site 110. When additional Products 108 are ordered by POS 116, processing site 110 automatically updates its database with information about the increased inventory of POS 116. Once Product 108 is used on a patient verified by processing site 110, processing site 110 can automatically updates its database with information about the decreased inventory of POS 116. Accordingly, an administrator or someone else affiliated with POS 116, can access processing site 110 to determine the current levels of Product 108 inventory. The administrator can use this inventory information to calculate future orders, to verify current inventory levels, and/or the like. In another embodiment, processing site 110 is configured to provide POS 116 an alert and/or other notification when levels of Product 108 reach a minimum threshold.

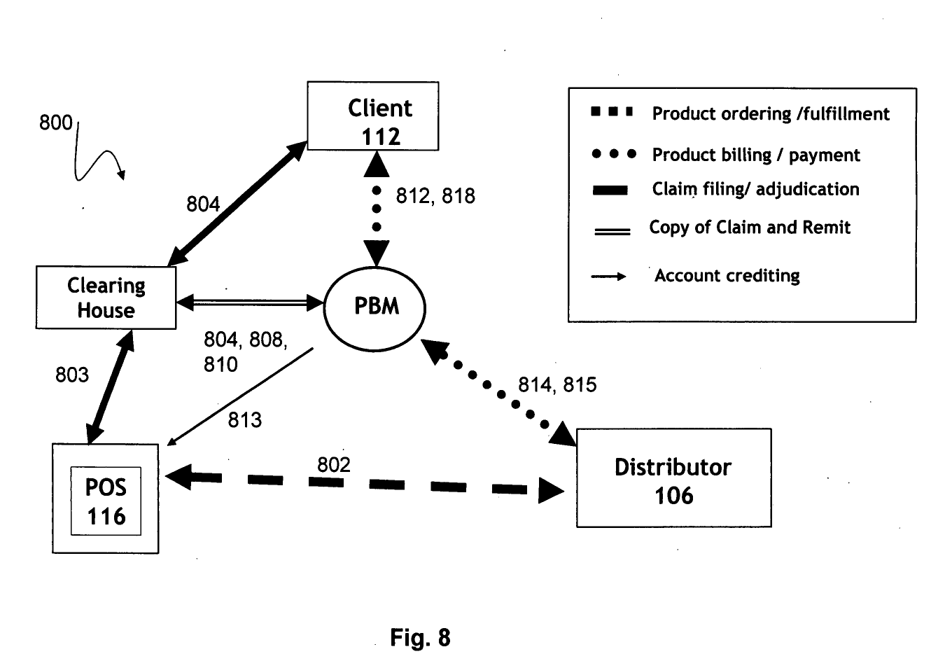

Referencing FIG. 8, an exemplary adjudication method 800 in accordance with the present invention is illustrated. POS 116 first orders a Product from distributor 106 (step 802). POS 116 can place the order in any manner known in the art. By placing the order, POS 116 and/or distributor 106 transmits information to a clearinghouse about the order (step 803). The clearinghouse then sends the Client and/or the pharmacy benefits manager (“PBM”) a claim for the Product (step 804).

As used herein, the term clearinghouse refers to any service that facilitates one or more aspects of a revenue cycle, such as insurance eligibility information, adjudication information, patient verification, claims compliance and submission, remittance advice, and/or patient billing. A PBM, as used herein, includes, but is not limited to any company under contract with managed care organizations, self-insured companies, health plans, and/or the like that provides pharmacy network management, drug utilization review, outcomes management, prescription fulfillment services and/or the like.

The claim that is transferred to Client 112 and/or the PBM can be any type of claim for a Product. In one exemplary embodiment, the claim is in the 837 format.

If the clearinghouse sends both Client 112 and the PBM the claim, then the PBM can retain the claim (step 806, not shown) until the PBM receives approval (step 812) from Client 112 to pay the claim (step 814). Meanwhile, Client 112 can adjudicate and/or remit to the clearinghouse for the services outlined in the claim (step 808). The remittance adjudicated by Client 112 may be in any type of format, however, in one exemplary embodiment, the remittance is in the 835 format.

The clearinghouse can then transfer a copy of the remittance to the PBM (step 810) and authorize the PBM to pay the claim (step 814). Alternatively, the PBM can reconcile the remission with the claim (step 816, not shown) before paying the claim (step 812).

By paying the claim, the PBM can credit the account of POS 116 (step 813) for the Products and/or the PBM can pay distributor 106 for the Product (step 815). After, before, or at the same time that the PBM credits the account of POS 116, the PBM can bill Client 112 (step 818) for the Product.

While the exemplary method illustrated in FIG. 8 illustrates one method of health plan adjudication, any method of adjudication may be used. Further, none of the steps or entities outlined in FIG. 8 are required for adjudication. For example, in one embodiment, the PBM may operate as a clearinghouse.

In addition, while FIG. 8 is described having a particular order to the steps, the steps described can be performed in any order. For example, retrospective processes for billing POS 116 and/or prospective processes for billing POS 116 may be implemented.

As will be appreciated by one of ordinary skill in the art, the present invention can be embodied as a method, a data processing system, a device for data processing, and/or a computer program product. Accordingly, the present invention can take the form of an entirely software embodiment, an entirely hardware embodiment, and/or an embodiment combining aspects of both software and hardware. Furthermore, the present invention can take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

The present invention has been described above with reference to various exemplary embodiments. However, those skilled in the art will recognize that changes in modifications may be made to the exemplary embodiments without departing from the scope of the present invention. As used herein, the terms “comprises,” “comprising,” and/or any other variation thereof, are intended to cover a non-exclusive inclusion, such that a process, method, article, and/or apparatus that comprises a list of elements does not include only those elements but may include other elements not expressly listed and/or inherent to such process, method, article, and/or apparatus. Further, no element described herein is required for the practice of the invention unless expressly described as “essential” and/or “critical.”

What is claimed:

1. A managed distribution system for distribution and billing a product, the system comprising:
a processing site configured for communicating with a distributor, a client and a point-of-service provider (“POS”), wherein the processing site facilitates delivery of a product from the distributor to the POS;
a billing system associated with the processing site, wherein the billing system is configured to bill the client for the Product delivered to the POS when the product is used to treat a patient who is a member/insured of the client.

2. The system of claim 1, wherein the processing site is configured with one or more databases to store information of at least one of a distributor, a client and a POS.

3. The system of claim 1, wherein the processing site is configured to receive registration information from at least one of a distributor, a client and a POS.

4. The system of claim 1, wherein the processing site is configured receive inventory information of the POS and communicate this information to the distributor.

5. The system of claim 1, wherein the product comprises at least one of a medical, health care, and pharmaceutical product.

6. The system of claim 1, wherein the POS comprises at least one of a physician, home infusion provider, physician clinic, group practice, pharmacist, medical practitioner, nurse, veterinarian, and long term care facility.

7. A method for distributing a product, the method comprising:
registering a client and a point-of-service (“POS”) with a distributor processing system;
receiving a product order from the POS at the processing system;
coordinating delivery of the product from the distributor to the POS;
verifying a patient of the client using the processing system;
approving the administration of the product to the patient by the POS; and
facilitating payment by the client to the distributor for the product.

8. The method for distributing a product of claim 7, further comprising reconciling billing between the client and the POS for the product.

9. The method for distributing a product of claim 7, further comprising deducting the product from an inventory of the POS.

10. The method for distributing a product of claim 7, the step of receiving a product order comprises receiving an order for at least one of a medical, health care, and pharmaceutical product.

11. The method for distributing a product of claim 7, wherein the step of registering a client and a point-of-service comprises registering a client and at least one of a physician, home infusion provider, physician clinic, group practice, pharmacist, medical practitioner, nurse, veterinarian, and long term care facility.

12. A method for adjudicating a claim for a product, the method comprising:
receiving a claim for a product from a clearinghouse, wherein product is ordered by a point-of-service provider (POS) from a distributor;
receiving a remittance from a client;
reconciling the claim with the remittance to form an approved amount;
crediting an account of the POS for the approved amount;
paying the distributor for the product; and
billing the client for the product.

13. The method of claim 12, wherein the step of receiving a claim for a product comprises receiving a claim for at least one of a medical, health care, and pharmaceutical product.

14. The method of claim 12, wherein the step of crediting an account of the POS comprises crediting the account of at least one of a physician, home infusion provider, physician clinic, group practice, pharmacist, medical practitioner, nurse, veterinarian, and long term care facility.
